(19) United States
(12) Patent Application Publication
(10) Pub. No.: US 2007/0172283 A1
(43) Pub. Date: Jul. 26, 2007

(54) Image forming system, Image forming apparatus and program for use therein

(75) Inventor: Takao Kurohata, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/586,683

(22) Filed: Oct. 26, 2006

(30) Foreign Application Priority Data
Jan. 13, 2006 (JP) JP2006-005933

(51) Int. Cl. B41J 11/44

(52) U.S. Cl. 400/76

(57) ABSTRACT

An image forming system includes: a page image input section which inputs page images including at least a text image and a spine image; a stamp setting section which establishes stamp setting information that indicates forming of a stamp image onto the page images inputted by the page image input section; an image forming section which forms the page images which have been inputted by the page image input section and the stamp image based on the stamp setting information onto a recording medium; and a controller which prohibits forming of the stamp image by the image forming section onto a spine area of the recording medium.

This application is based on Japanese Patent Application No. 2006-5933 filed on Jan. 13, 2006, which is incorporated hereinto by reference.

### BACKGROUND OF THE INVENTION

The present invention relates to an image forming system, an image forming apparatus and a program.

There is known an image forming system having a wrapping bookbinding function that forms a booklet by wrapping a text on which images are formed (a sheet bundle) with a single sheet on which a front cover, a spine and a back cover are in a U-shaped form (see, for example, Japanese Patent Application Publication No. 2002-361967).

On the other hand, there is known a page print method complying with a booklet form in an image forming apparatus that creates a booklet in which superposed transfer sheets are folded double (see, for example, Japanese Patent Application Publication No. 2001-274977).

However, in Japanese Patent Application Publication Nos. 2002-361967 and 2001-274977), there is no description about a stamp-printing method for stamps of page numbers, a company secret and strictly prohibited copy in a wrapping bookbinding style.

### SUMMARY OF THE INVENTION

The present invention has been achieved in view of the aforesaid problems, and its object is to provide an image forming system, an image forming apparatus and a program which make it possible to conduct stamp-printing suitable for wrapping bookbinding style.

The object mentioned above can be attained by any one of the following structures.

The image forming system of the invention has therein a page image input section that inputs page images including at least a text image and a spine image, a stamp setting section that establishes stamp setting information that shows forming of stamp images for page images inputted by the page image input section, an image forming section that forms page images inputted by the page image input section and stamp images based on the stamp setting information onto a recording medium and a controller that prohibits forming of stamp images by the image forming section, for the spine area.

The image forming apparatus of the invention has therein a page image input section where page images including a spine image are inputted, a stamp setting information input section where stamp setting information showing forming of a stamp image for page images inputted by the page image input section is inputted, an image forming section that forms page image inputted by the page image input section and stamp images based on stamp setting information inputted by the stamp setting information input section, on a recording medium and a controller that prohibits forming of stamp images by the image forming section, for the spine area, despite an occasion where stamp setting information by the stamp setting information input section is showing forming of stamp images.

The program of the invention causes a computer to perform a page image input step where page images including a spine image are inputted, a stamp setting information input step where stamp setting information showing that a stamp image is formed for page images inputted by the page image input step, is inputted, an image forming step to form, on a recording medium, page images inputted by the page image input step and stamp images based on stamp setting information inputted by the stamp setting information input step, and a control step to prohibit forming of stamp images by the image forming step, for the spine area, despite an occasion where stamp setting information by the stamp setting information input step is showing that stamp images are formed.

### BRIEF DESCRIPTION OF THE DRAWINGS

FIG. 1 is a block diagram showing the configuration of an image forming system relating to the present embodiment.

Each of FIGS. 2(a)-2(c) is an example of page print carried out on image forming section 16 of a wrapping bookbinding type relating to the present embodiment, and it shows a page print example wherein input page images are transmitted in the order of a front cover, a text, a back cover and a spine.

Each of FIGS. 3(a)-3(c) is an example of page print carried out on image forming section 16 of a wrapping bookbinding type relating to the present embodiment, and it shows a page print example wherein input page images are transmitted in the order of the compounded image for the front cover, back cover and spine and of the text.

FIG. 4 is a flow chart showing page print control relating to the present embodiment.

### DETAILED DESCRIPTION OF THE PREFERRED EMBODIMENT

### (System Structure)

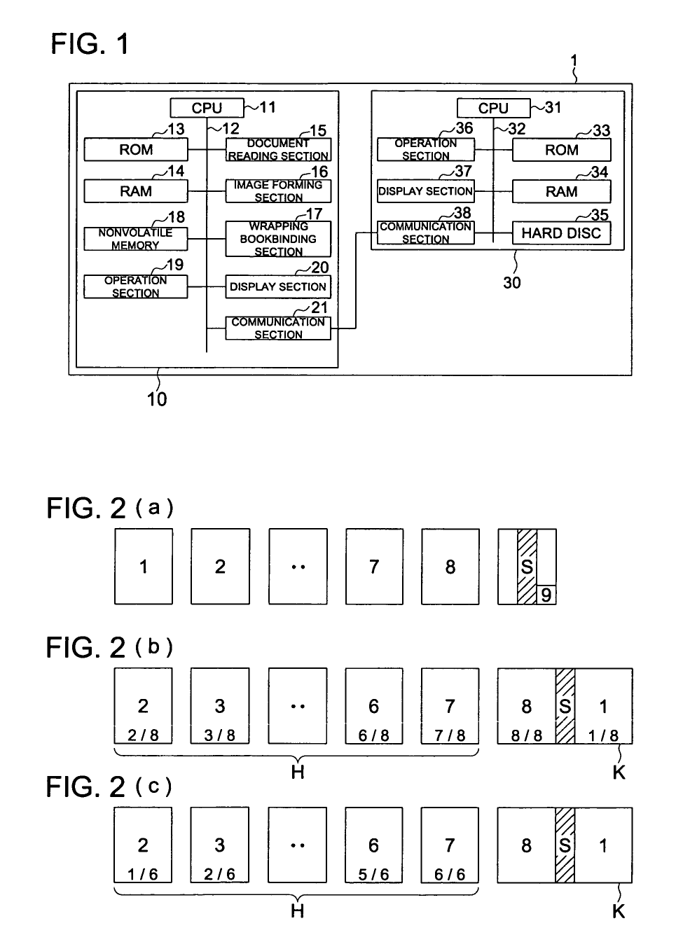

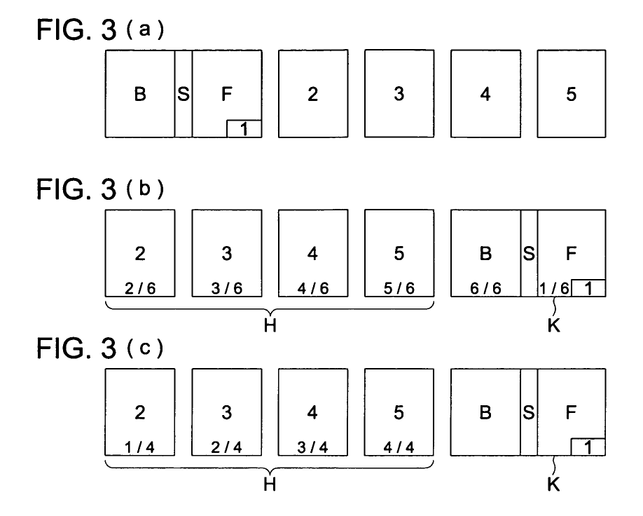

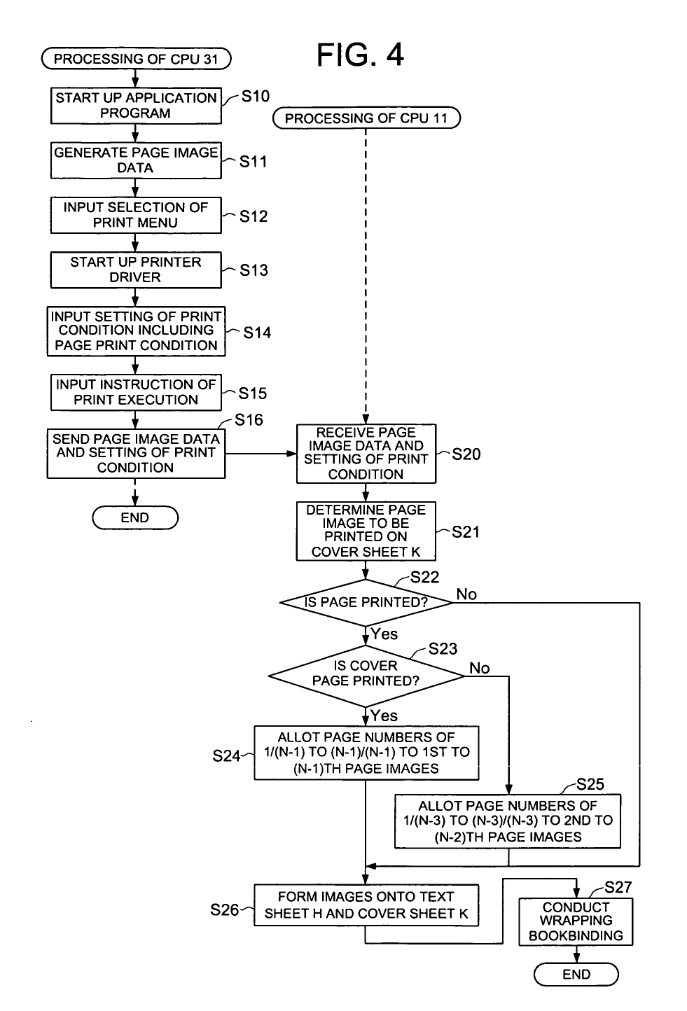

FIG. 1 is a block diagram showing the structure of an image forming system relating to the present embodiment. The image forming system is composed of image forming apparatus 10 and personal computer 30. The image forming apparatus 10 conducts image forming on a recording medium based on image data transmitted from personal computer 30 or from document reading section 15 of the image forming apparatus 10, and conducts wrapping bookbinding. Meanwhile, in the present embodiment, there is explained, as a wrapping bookbinding method, an example wherein a sheet for a cover that covers a bundle of recording media in a U-shaped form and the bundle of recording media are glued together with adhesive agents coated on a spine of the bundle of recording media, to which, however, the invention is not limited. The wrapping bookbinding method has only to be one that binds a book by wrapping a bundle of recording media in a U-shaped form with a sheet for a cover, and it may also be one, for example, in which a recording medium bundle and a sheet for a cover are fixed together through stapling.

In the image forming apparatus 10, ROM 13, RAM 14, document reading section 15, image forming section 16, wrapping bookbinding section 17, nonvolatile memory 18, operation section 19, display section 20 and communication section 21 are connected to each other through bus 12, with a focus on CPU 11 that conducts various controls of the image forming apparatus 10 in accordance with programs.

The ROM 13 stores various programs and data which are utilized by CPU 11 to control the image forming apparatus 10.

The RAM 14 is utilized by CPU 11 as a work area, and programs and data which are needed when CPU 11 conducts controls are stored temporarily in the RAM 14.

The document reading section 15 reads a document and generates image data. Image data thus generated are outputted to the image forming section 16.

The image forming section 16 forms images on a recording medium based on image data inputted from the document reading section 15 or from personal computer 30.

The wrapping bookbinding section 17 conducts wrapping bookbinding by processing a recording medium conveyed from the image forming section 16.

The nonvolatile memory 18 stores page numbers and images of various stamps.

The operation section 19 is operated by a user, and selections of various modes and instructions of image forming are inputted.

The display section 20 displays various operation image areas and setting image areas. The display section 20 may also be composed of a touch panel to serve also as the operation section 19.

The communication section 21 is connected with personal computer 30, and receives image data transmitted from personal computer 30.

In the personal computer 30, ROM 33, RAM 34, hard disc 35, operation section 36, display section 37 and communication section 38 are connected to each other through bus 32, with a focus on CPU 31 that conducts controls of the personal computer 30 in accordance with programs.

The ROM 33 stores various programs and data which are utilized by CPU 31 to control the personal computer 30.

The RAM 34 is utilized by CPU 31 as a work area, and programs and data which are needed when CPU 31 conducts controls are stored temporarily in the RAM 34.

The hard disc 35 stores application programs for generating image data and printer drivers.

The operation section 36 is operated by a user, and various inputs are conducted on an image area of application programs and on an image area of printer drivers.

The display section 37 displays an image area of application programs and an image area of printer drivers.

The communication section 38 is connected with image forming apparatus 10 and transmits image data to the image forming apparatus.

### (Outline of Page Print)

Next, as an example of stamp images, there will be explained an occasion of printing page numbers. Each of FIGS. 2(a)-2(c) and FIGS. 3(a)-3(c) shows an example of page print conducted in image forming section 16 in a wrapping bookbinding type, which is just an example, to which the invention is not limited. In the meantime, it is assumed that printing is carried out on one side of a sheet.

Each of FIGS. 2(a)-2(c) shows an example of page print in the occasion where input page image data are transmitted to image forming apparatus 10, in the order of a front cover, a text (a recording medium bundle covered with a sheet for covers including the front cover and the back cover), a back cover and a spine. FIG. 2(a) shows an order of input page image data inputted in image forming apparatus 10, and the first one corresponds to page image data of the front cover, 2^{nd}-7^{th} ones correspond to page image data of the text, 8^{th} one corresponds to page image data of the back cover 9^{th} one corresponds to page image data of the spine. These page image data are inputted from a page image input section (for example, personal computer 30 or document reading section 15).

FIG. 2(b) shows an order of sheets representing recording media outputted from image forming section 16 and page print conditions in the case of conducting page print on front cover sheet K representing a sheet for a front cover. First, 2^{nd}-7^{th} input page images and page numbers 2/8-7/8 are printed in order on text sheet H. Next, first input page image corresponding to a front cover image, 8^{th} input page image corresponding to a back cover image, 9^{th} input page image corresponding to spine image S, page number 1/8 corresponding to a front cover image and page number 8/8 corresponding to a back cover image are compounded and printed on front cover sheet K. For the 9^{th} input page image corresponding to spine image S, no page print is carried out. Incidentally, denominator portions for page numbers 1/8-8/8 printed in FIG. 2(b) represents the total page numbers which are the sum of the page numbers corresponding to the text, the page numbers corresponding to the front cover and the page numbers corresponding to the back cover, in FIG. 2(b). In other words, in FIG. 2(b), the total page number is determined by counting page numbers excluding page numbers corresponding to the spine.

FIG. 2(c) shows an order of sheets outputted from image forming section 16 and how page print is conducted in the occasion where no page print is conducted on front cover sheet K. First, 2^{nd}-7^{th} input page images and page numbers 1/6-6/6 are printed in order on text sheet H. Next, first input page image corresponding to a front cover image, 8^{th} input page image corresponding to a back cover image, 9^{th} input page image corresponding to spine image S are compounded and printed on front cover sheet K. For the first input page image corresponding to the front cover image, the eighth input page image corresponding to the back cover image and the ninth input page image corresponding to the back cover image, no page print is conducted. Meanwhile, in FIG. 2(c), the total page number is determined by counting page numbers excluding page numbers corresponding to the spine, the front cover and the back cover.

In FIGS. 2(a)-2(c), page print is not conducted for at least the spine, as stated above, and a page number corresponding at least to the spine is not included the page number determining the total page number. Owing to this, an attractive booklet having therein page prints conforming to the bound booklet can be created.

Each of FIGS. 3(a)-3(c) shows an example of page prints in the case where input page images are transmitted in the order of compounded images of front cover image F, back cover image B and spine image S and a text. FIG. 3(a) shows an order of input page images inputted in image forming apparatus 10, and the first one corresponds to compounded images of front cover image F, back cover image B and spine image S, and each of the second to the fifth corresponds to a page image of the text image. These page images are inputted from personal computer 30 or from document reading section 15.

FIG. 3(b) shows an order of sheets outputted from image forming section 16 and how page print is conducted, in the case of conducting page print on front cover sheet K. First, 2^{nd}-5^{th} input page images and page numbers 2/6-5/6 are printed in the order on text sheet H. Next, first input page image corresponding to compounded images including front cover image F, back cover image B and spine image S, page number 1/6 corresponding to front cover image F, and page number 6/6 corresponding to back cover image B are printed on front cover sheet K. For spine image S, no page print is conducted. Further, total page number 6 is determined by counting page number excluding page number 1 corresponding to the spine.

FIG. 3(c) shows an order of sheets outputted from image forming section 16 and how page print is conducted, in the case of conducting no page print on front cover sheet K. First, 2^{nd}-5^{th} input page images and page numbers 1/4-4/4 are printed in the order on text sheet H. Next, first input page image corresponding to compounded images including front cover image F, back cover image B and spine image S is printed on front cover sheet K. For the first input page image corresponding to compounded images including front cover image F, back cover image B and spine image S, no page print is conducted. Further, the total page number 4 is determined by counting page numbers excluding page numbers corresponding to the spine, the front cover and the spine.

In the aforesaid example, an explanation was given to the occasion where printing is carried out on one side of the sheet, but this can apply also to the occasion where printing is carried out on both sides of the sheet.

### (Page Print Control)

FIG. 4 is a flow chart showing page print control relating to the present embodiment. As an example, there is shown a flow chart for the occasion of FIGS. 2(a)-2(c). Incidentally, it is assumed that input page image data are transmitted from personal computer 30.

### <Control of Personal Computer 30>

First, when an instruction for starting an application program is given from operation section 36 in the personal computer 30, CPU 31 starts the application program, to load it on RAM 34 from hard disc 35, and displays an application image area on display section 37 (step S10). Next, CPU 31 generates page image data shown in FIG. 2(a) based on an input from operation section 36 for the application program image area (step S11).

Next, when print menu is selected by operation section 36 on an application image area (step S12), CPU 31 starts a printer driver to load it on RAM 34 from hard disc 35, and displays a printer driver image area on display section 37 (step S13).

Next, setting of print conditions including page print condition and stamp setting such as “wrapping bookbinding: Yes”, “input page image form: order of front cover, text, back cover and spine”, “text: print on one side”, “cover: print on one side”, “page print: Yes” and “cover page print: Yes” are carried out by operation section 36 (stamp setting section) on a printer driver image area, and they are inputted in CPU 31 (step S14).

Next, when an instruction for print practice is given by the operation section 36 (step S15), CPU 31 transmits page image data prepared in step S11 and print condition setting inputted in step S14 to image forming apparatus 10 through communication section 38 (step S16).

### <Control of Image Forming Apparatus>

CPU 11 of image forming apparatus 10 receives page image data and print condition setting transmitted in step S16 from personal computer 30 through communication section 21, and causes RAM 14 to store them (step S20).

Next, based on print condition setting stored in RAM 14, the CPU 11 determines a page image to be printed on cover sheet K, from page image data stored in RAM 14 (step S21). In the present embodiment, setting of “input page image form: front cover, text, back cover and spine”, “text: printing on one side” and “cover: printing on one side” determines so that the first page image representing the first may become a front cover image, 8^{th} page image representing the last but one may become a back cover image, and 9^{th} page image representing the last may become a spine image.

Next, CPU 11 judges whether page print should be conducted or not, based on print condition setting stored in RAM 14 (step S22). When the page print is judged to be conducted (step S22; Yes), CPU 11 judges whether cover page print should be conducted or not, (step S23). When the page print is judged not to be conducted (step S22; No), CPU 11 advances to step S26. In the present embodiment, page print is judged to be conducted by setting of “page print: Yes”, and the flow advances to step S23.

When cover page print is judged to be conducted in step S23 (step S23; Yes), CPU 11 allots page 1 to the first page image, page 2 to the second page image, . . . , and page (N-1) to (N-1)^{th} page image, when the number of page images is N. Further, it allots (N-1) as the total page number (step S24). For the N^{th} image representing spine image S, no page number is allotted. In the present embodiment, no page number is allotted to N^{th} image representing spine image S, which results in prohibition of printing of page number on the spine.

When cover page print is judged not to be conducted in step S23 (step S23; No), CPU 11 allots page 1 to the second page image, page 2 to the third page image, . . . , and page (N-3) to (N-2)^{th} page image, when the number of page images is N. Further, it allots (N-3) as the total page number (step S25). For the first image representing a front cover image, (N-1)th image representing a back cover and for N^{th} image representing spine image S, no page number is allotted. In the present embodiment, page number allotment is one shown in FIG. 2(c).

In step 26, CPU 11 controls image forming section 16 so that page images excluding page images to be printed on cover sheet K determined in step S21 may be printed on text sheet H in the order for the page images to be inputted, and when page numbers are allotted to the page images, CPU 11 reads out page number images corresponding to the allotted page numbers from nonvolatile memory 18, and controls image forming section 16 to print on the text sheet H. Further, CPU 11 controls image forming section 16 so that page images to be printed on cover sheet K determined in step S21 may be printed on the cover sheet K.

Next, CPU 11 controls wrapping bookbinding section 17 to conduct wrapping bookbinding by wrapping text sheet H which has been subjected to printing by image forming section 16 with cover sheet K which has been subjected to printing by image forming section 16 (step S27).

In the present embodiment, a page number is not allotted for at least a spine image as stated above, whereby, a page number is not printed on a spine portion of cover sheet K, and page print that is suitable for the wrapping bookbinding type can be carried out. It is further possible to conduct appropriated page print, because the total page number is counted by excluding spine images to be printed.

With respect to input page image data in FIG. 2(a), spine images are page image data which are independent of other page image data, in other words, a page of spine image data is different from a page of other page image data, thus, it is possible to set so that a stamp cannot be allotted easily on a page unit, which is preferable.

In FIG. 4, a flow of page number print in the case of FIGS. 2(a)-2(c) was explained, and the same can be applied even in the case of FIGS. 3(a)-3(c), in step S20, by recognizing that image data inputted are in the order of FIG. 3(a).

In the present embodiment, input page images were prepared and print conditions were established both in personal computer 30. However, it is also possible to prepare input page images by reading documents with document reading section 15 of image forming apparatus 10 and to establish print conditions including stamp setting with operating section 19 (stamp setting section) of image forming apparatus 10.

Though document reading section 15 and wrapping bookbinding section 17 are provided on image forming apparatus 10 in the present embodiment, each of the document reading section 15 and the wrapping bookbinding section 17 may also be one that is independent of the image forming apparatus 10.

In the present embodiment, an occasion of page print was explained as stamp print. Even in the case of print for “a company secret” or “strict prohibition for copy”, it is possible to conduct print that is suitable for a wrapping bookbinding style, by conducting no allotment for the print for at least spine images.

In the present invention, stamps are not allotted for at least spine images, and thereby, stamps are not printed on the spine portion of a cover sheet, and stamp print suitable for the wrapping bookbinding style can be carried out.

What is claimed is:

1. An image forming system comprising:
(a) a page image input section which inputs page images including at least a text image and a spine image;
(b) a stamp setting section which establishes stamp setting information that indicates forming of a stamp image onto the page images inputted by the page image input section;
(c) an image forming section which forms the page images which have been inputted by the page image input section and the stamp image based on the stamp setting information onto a recording medium; and
(d) a controller which prohibits forming of the stamp image by the image forming section onto a spine area of the recording medium.

2. The image forming system of claim 1, wherein the stamp setting section is capable of establishing forming of the stamp image onto a cover image including at least the spine image, and the controller prohibits forming of the stamp image by the image forming section onto the spine area, despite an occasion where forming of the stamp image onto the cover image is set by the stamp setting section.

3. The image forming system of claim 1, wherein the controller does not allot the stamp image to the spine area.

4. The image forming system of claim 1, wherein the stamp image represents a page number.

5. The image forming system of claim 4, wherein the page number includes a total number of pages, the controller counts the total number of pages excluding a page for the spine image.

6. An image forming apparatus comprising:
(a) a page image input section which inputs a page image including a spine image;
(b) a stamp setting information input section where stamp setting information indicating that a stamp image is formed onto the page image inputted by the page image input section, is inputted;
(c) an image forming section which forms the page image inputted by the page image input section and the stamp image based on the stamp setting information inputted by the stamp setting information input section, onto a recording medium; and
(d) a controller which prohibits forming of the stamp image by the image forming section onto a spine area, despite an occasion where the stamp setting information by the stamp setting information input section shows forming of the stamp image.

7. The image forming apparatus of claim 6, wherein the stamp image represents a page number.

8. The image forming apparatus of claim 6, wherein the page number includes a total number of pages, the controller counts the total number of pages excluding a page for the spine image.

9. A program making a computer to perform, the program comprising the steps of:
(a) inputting a page image including a spine image;
(b) inputting stamp setting information where stamp setting information indicating that a stamp image is formed onto the page image inputted by the page image inputting step;
(c) forming the page image inputted by the page image inputting step and the stamp image based on the stamp setting information inputted by the stamp setting information inputting step onto a recording medium; and
(d) controlling to prohibit forming of the stamp image by the image forming step onto a spine area, despite an occasion where the stamp setting information by the stamp setting information inputting step shows forming of the stamp image.

10. The program of claim 9, wherein the stamp image represents a page number.

11. The program of claim 9, wherein the page number includes a total number of pages, the controller counts the total number of pages excluding a page for the spine image.
